(19) United States
(12) Patent Application Publication
(10) Pub. No.: US 2013/0117080 A1
(43) Pub. Date: May 9, 2013

(54) SYSTEM AND METHOD FOR A USER INTERFACE TO PROVIDE INFORMATION ABOUT OFFERS EXTRACTED FROM A MARKETING COMMUNICATION

(71) Applicants: Mark Hunter Madsen, Vancouver (CA); June Oakes, Glen Mills, PA (US); William Nicholas Weir, Phoenixville, PA (US)

(72) Inventors: Mark Hunter Madsen, Vancouver (CA); June Oakes, Glen Mills, PA (US); William Nicholas Weir, Phoenixville, PA (US)

(73) Assignee: ChoozOn Corporation, King of Prussia, PA (US)

(21) Appl. No.: 13/292,039

(22) Filed: Nov. 8, 2011

(51) Int. Cl. G06Q 30/02

(52) U.S. Cl. 705/14.1

(57) ABSTRACT

An improved system and method for generating offers from marketing communications is provided. Marketing communications, including marketing emails, may be received, and offer information may be extracted from the marketing communications. A marketing message retrieved may be parsed to identify and extract offer information including the brand, headline text, description, and other content. Offers may be generated from the offer information extracted from the marketing communications, and may be stored in persistent storage for serving to users of an online offer service through a variety of user interfaces. In various embodiments, messages identified from recognized brands may be presented in a graphical user interface for a user to read with messages from unrecognized brands. Furthermore, either the message or an offer generated from a message may be displayed in various embodiments through a variety of user interfaces where its relevance may be specified by a user's interests.

### CROSS-REFERENCE TO RELATED APPLICATIONS

The present invention is related to the following United States patent application, filed concurrently herewith and incorporated herein in its entirety:

“System and Method for Extracting Offers from a Marketing Communication,” Attorney Docket No. 0001.

### FIELD OF THE INVENTION

The invention relates generally to computer systems, and more particularly to an improved system and method for extracting and presenting offers from a marketing communication to a user of an online offer service.

### BACKGROUND OF THE INVENTION

In the emerging web-based deal economy today, merchants representing thousands of different products work with affiliate networks of online publishers that post their offers across hundreds or thousands of locations on the Web. These merchants operate an infrastructure or engage specialized networks such as Commission Junction, LinkShare, or the Google Affiliate Network that provide services which carefully track actions by online users on online publisher websites, such as impressions viewed, click-throughs and purchases, and typically compensate by commissions the publishers who drive leads and sales.

A number of online publisher websites have become aggregators of deals and coupons, such as Coupon Mountain and Coupon Cabin. These online publishers focus on aggregating the largest number of offers from the largest number of brands possible, and some have built coupon directories representing thousands of coupons. To increase the number of deals published on their websites, some aggregators such as RetailMeNot and SlickDeals invite the public to post deals on their websites that were found elsewhere. Although such websites attract a large online audience, consumers are easily overwhelmed by the number of deals on these websites and often suffer a tedious and daunting user experience from searching through the giant inventory in these website directories to find relevant deals and coupons. As a result, many consumers experience deal fatigue from browsing such websites and abandon their search without finding relevant deals or coupons.

On the other end of the spectrum, some online publisher websites feature one or relatively few daily deals. In particular, group discount buying was introduced by Living Social, popularized by Groupon, and quickly emulated by hundreds of such websites offering deals in every major American city. Such websites send one deal per day that is price-discounted by 50% to 80% if group buying minimums are met. Whereas online publisher websites of giant coupon directories may overwhelm consumers with excessive choices, deal-of-the-day websites may feature a rather narrow range of high-margin, low-cost services from local businesses that may not always be relevant to a consumer. Moreover, consumers who sign up for one or more of these daily-deal services find that their personal email inboxes quickly become overloaded with the proliferation of offers awaiting their attention.

In addition to working with affiliate networks of online publishers that post their offers across hundreds or thousands of locations on the Web, merchants also send marketing communications that include offers directly by email to consumers. Some marketing communications sent by email represent unsolicited bulk email messages, also known as “spam,” sent indiscriminately to a large number of consumers. Many other marketing communications sent by email are requested by consumers from brands that they like. Unfortunately, a consumer's email inbox may receive many emails from marketers that are spam as well as requested marketing communications with offers that are relevant to that individual consumer.

Whether browsing on coupon warehouse websites, daily deal websites or in their email inbox, many consumers find it too difficult to discover relevant deals online and become frustrated by surfing multiple websites or the growing clutter within their email inboxes in search of relevant deals. What is needed is a system and method by which an online consumer can easily discover relevant offers online and in their email inbox, and can organize their incoming messages to help them distinguish easily between deal-related commercial correspondence and other kinds of email messages. Such a system and method should allow users to find offers for products they want and brands they like.

### SUMMARY OF THE INVENTION

Briefly, the present invention may provide a system and method for generating offers from marketing communications and seamlessly present such offers to a user of an online offer service among offer displayed for brands, product types, offer lists, and other views available in the online offer service. In various embodiments, a marketing client may be operably connected to a messaging server, and the messaging server may be operably connected to an offer server. The marketing client may include functionality for receiving a request to generate a marketing communication, functionality for tagging the marketing communication, and functionality for sending the marketing communication to a user's marketing communication inbox on the messaging server. Marketing messages delivered to the messaging server may be stored for email accounts in a messaging database and may be periodically processed to extract offers from the marketing communications received in an embodiment. To do so, a message processor executing on the offer server may retrieve new messages stored for user email accounts from the messaging server. The messaging processor may be operably connected to an offer extract engine with functionality to extract offer information from marketing messages and an offer generating engine with functionality to generate offers for loading into data storage with offers for the online offer service.

In an embodiment, a new message retrieved may be parsed to identify and extract offer information including the brand, headline text, description, and other content. In various embodiments, marketing messages may be tagged in order to identify and delineate information about an offer including the offer description, the offer expiration date, a coupon code, and so forth. An offer may be generated from the offer information extracted and loaded into persistent data storage. The offer may thus be seamlessly integrated into the data storage of offers in the online offer service and may be accessible by the user who received the marketing message. In various embodiments, an offer generated from a marketing message may be published and visible for other users in the online offer service. Such publication of the offer may occur through various notification channels associated with a particular user, including but not limited to a web browser, an email application, and messaging applications.

When processing new marketing messages, a message may be identified from a recognized brand in which a user may have indicated a preference. In an embodiment, messages identified from a recognized brand in which the user may have indicated a preference may be presented in a graphical user interface with user input controls to selectively read such messages. In other embodiments, messages identified from recognized brands may be presented in a graphical user interface for a user to read with messages from unrecognized brands. Furthermore, offers extracted and loaded into data storage may be retrieved and displayed in any of these embodiments, or an offer generated from a message may be displayed, or the message may instead be displayed.

Advantageously, the present invention may receive marketing communications, including marketing emails, generate offers from marketing communications, and store the offer extracted in persistent storage for serving to users of an online offer service through a variety of user interfaces where its relevance may be specified by a user's interests. Conveniently, the present invention may easily organize incoming messages to help users distinguish between deal-related commercial correspondence and other kinds of email messages. Furthermore, the invention may flexibly allow an online consumer to easily discover relevant offers in their email inbox for products they want and brands they like.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for generating offers from marketing communications to a user of an online offer service, in accordance with an aspect of the present invention;

FIG. 3 is a flowchart generally representing the steps undertaken in an embodiment for sending a marketing message to a marketing communication inbox, in accordance with an aspect of the present invention;

FIG. 4 is a flowchart generally representing the steps undertaken in an embodiment for processing marketing communication messages to extract offers, in accordance with an aspect of the present invention;

FIG. 5 is a flowchart generally representing the steps undertaken in an embodiment for receiving a marketing communication message, in accordance with an aspect of the present invention;

FIG. 6 is a flowchart generally representing the steps undertaken in an embodiment for configuring a marketing communication inbox, in accordance with an aspect of the present invention;

FIG. 7 is an exemplary illustration generally representing a screen of a graphical user interface with user input controls to configure a marketing communication inbox, in accordance with an aspect of the present invention;

FIG. 8 is a flowchart generally representing the steps undertaken in an embodiment for processing a marketing communication message received for a marketing communication inbox, in accordance with an aspect of the present invention;

FIG. 9 is a flowchart generally representing the steps undertaken in an embodiment for configuring a brand address map that may be used to identify a recognized brand, in accordance with an aspect of the present invention;

FIG. 10 is a flowchart generally representing the steps undertaken in an embodiment for processing a new marketing communication message, in accordance with an aspect of the present invention;

FIG. 11 is a flowchart generally representing the steps undertaken in another embodiment for processing a new marketing communication message, in accordance with an aspect of the present invention;

FIG. 12 is a flowchart generally representing the steps undertaken in an embodiment for extracting one or more offers from a marketing communication message, in accordance with an aspect of the present invention;

FIG. 13 is a flowchart generally representing the steps undertaken in an embodiment for extracting offer elements for an offer, in accordance with an aspect of the present invention;

FIG. 14 is a flowchart generally representing the steps undertaken in an embodiment for generating a new offer, in accordance with an aspect of the present invention;

FIG. 15 is a flowchart generally representing the steps undertaken in an embodiment for publishing a new offer extracted from a marketing communication message, in accordance with an aspect of the present invention;

FIG. 16 is an exemplary illustration in an embodiment generally representing a screen of a graphical user interface displaying notification of new marketing messages received in a marketing communication inbox with user input controls to read the new marketing messages in the marketing communication inbox, in accordance with an aspect of the present invention;

FIG. 17 is a flowchart generally representing the steps undertaken in an embodiment with a graphical user interface for displaying messages received in a marketing communication inbox for brands selected by a user, in accordance with an aspect of the present invention;

FIG. 18 is an exemplary illustration in an embodiment generally representing a screen of a graphical user interface displaying offers extracted from marketing messages received in a marketing communication inbox for brands selected by a user, in accordance with an aspect of the present invention;

FIG. 19 is a flowchart generally representing the steps undertaken in one embodiment with a graphical user interface for displaying messages received in a marketing communication inbox for brands not selected by a user, in accordance with an aspect of the present invention;

FIG. 20 is an exemplary illustration in an embodiment generally representing a screen of a graphical user interface displaying notification of new marketing messages received in a marketing communication inbox and one of more offers extracted from the marketing message, in accordance with an aspect of the present invention;

FIG. 21 is a flowchart generally representing the steps undertaken in one embodiment with a graphical user interface for displaying offers and their related information extracted from the messages for recognized brands, in accordance with an aspect of the present invention;

FIG. 22 is an exemplary illustration in an embodiment generally representing a screen of a graphical user interface displaying information about offers for both recognized brands and unrecognized brands that are extracted from marketing messages received in a marketing communication inbox, in accordance with an aspect of the present invention;

FIG. 23 is an exemplary illustration in an embodiment generally representing a screen of a graphical user interface displaying offers for a brand that includes offers extracted from marketing messages received in a marketing communication inbox for the brand, in accordance with an aspect of the present invention; and

FIG. 24 is a flowchart generally representing the steps undertaken in one embodiment with a graphical user interface for retrieving and displaying offers, including offers extracted from a marketing message in a marketing communication inbox, in accordance with an aspect of the present invention.

### DETAILED DESCRIPTION

### Exemplary Operating Environment

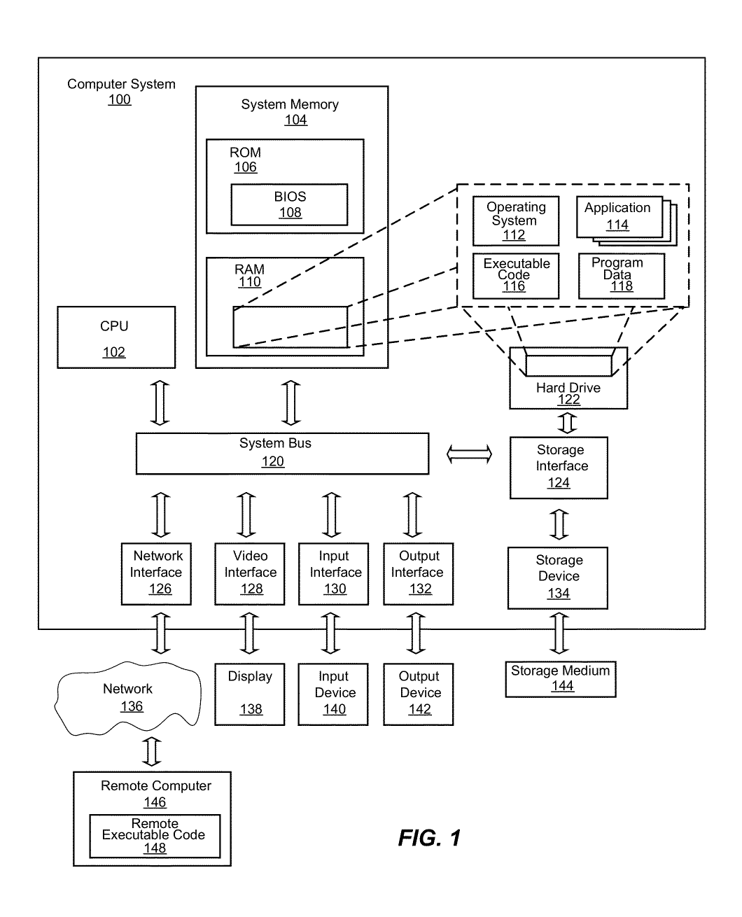

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be a solid-state drive that reads from or writes to non-removable, nonvolatile solid-state storage. Alternatively, storage device 134 may be a solid-state drive, an optical disk drive or a magnetic disk drive that reads from or writes to a removable, a nonvolatile storage medium 144 such as solid-state storage, an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Those skilled in the art will appreciate that the computer system 100 may also be implemented within a system-on-a-chip architecture including memory, external interfaces and an operating system.

Generating Offers from Marketing Communications

The present invention is generally directed towards a system and method for generating offers from marketing communications. More particularly, the present invention may receive marketing communications, including marketing emails, and store them in a centralized storage such as a marketing communication inbox. Promotional offers may then be generated from marketing communications and stored for serving to users of an online offer service. Furthermore, the offers stored for serving may be presented through a graphical user interface and various notification channels as may be requested by a user. As used herein, a marketing communication may mean a variety of content for marketing goods or services including text, voice, images, music, video, audio, other multimedia content and so forth, and such marketing communications may be sent in various embodiments by messaging applications like email applications, instant messaging applications, and other messaging applications.

As will be seen, the invention may easily organize their incoming messages to help them distinguish between deal-related commercial correspondence and other kinds of email messages. Furthermore, the invention may flexibly allow an online consumer to easily discover relevant offers in their email inbox for products they want and brands they like. As used herein, an offer or promotional offer means any online promotion for goods or services, including without limitation coupons, vouchers, advertisements, and so forth. An offer list is a list of multiple offers, and, in an embodiment, may also include one or more offer lists. As will be understood, the various block diagrams, flow charts and scenarios described herein are only examples, and there are many other scenarios to which the present invention will apply.

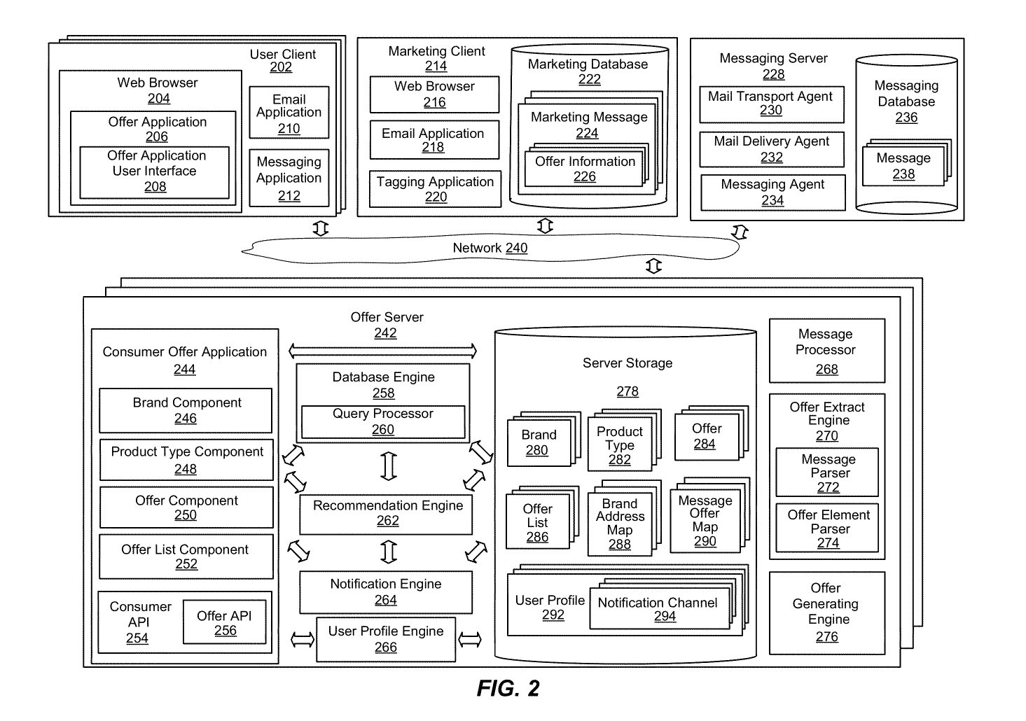

Turning to FIG. 2 of the drawings, there is shown a block diagram generally representing an exemplary architecture of system components for generating offers from marketing communications to a user of an online offer service. Those skilled in the art will appreciate that the functionality implemented within the blocks illustrated in the diagram may be implemented as separate components or the functionality of several or all of the blocks may be implemented within a single component. For example, the functionality for the offer application 206 on the user client 202 may be implemented as a separate component from the web browser 204, which may be the case for a mobile device such as a smartphone. Note that in an embodiment on a mobile device, the functionality of the offer application 206 may be implemented both within the web browser 204 as shown and as a separate component so that a mobile device user may use either the web browser 204 with the functionality of the offer application 206 included or the offer application 206 as a separate application component. As another example, the functionality of the message processor 268, the offer extract engine 270 and the offer generating engine 276 may be implemented in an alternate embodiment within a single component. Moreover, those skilled in the art will appreciate that the functionality implemented within the blocks illustrated in the diagram may be executed on a single computer or distributed across a plurality of computers for execution. Furthermore, those skilled in the art may also appreciate that the functionality of the present invention may also be implemented using a thin client whereby the functionality of the web browser 204, the offer application 206, the email application 210, and the messaging application 212 may be implemented on the offer server 242. In such an embodiment, the user client 202 merely acts as an interface for a user to interact with the offer server 242.

In various embodiments, a user client 202 may communicate with one or more offer servers 242 through a network 240. The user client 202 may be a computer such as computer system 100 of FIG. 1 or another computing device including a mobile device such as a mobile phone. The network 240 may be any type of network such as a local area network (LAN), a wide area network (WAN), or other type of network. A web browser 204 may execute on the user client 202 and may include functionality for receiving a request to perform an operation which may be input by a user and functionality for sending the request to a server to perform the operation. The web browser 204 may be operably coupled to an offer application 206 having functionality for receiving requests to perform an operation for the offer application 206 and functionality for sending the requests to the offer server 242 to perform the requested operation for the offer application. The offer application 206 may be operably coupled to an offer application user interface 208 having functionality for visualization and navigation of a graphical user interface for requesting and displaying information about offers available from multiple offer sources, such as brands, product types, offer lists and so forth, and more particularly, for receiving input from a user interacting through the graphical user interface to request performance of an operation for the offer application and functionality for displaying results received from the offer server 242 after performing the requested operation for the offer application.

Other applications may also execute on the user client 202 in various embodiments. For example, in embodiments where the user client 202 may be a computing device such as a mobile phone, an offer application 206 operably coupled with an offer application user interface 208 may execute on the mobile phone.

The offer application 206 in this embodiment may have functionality for receiving requests to perform an operation for the offer application and functionality for sending the requests to the offer server 242 to perform the requested operation for the offer application. The offer application user interface 208 in this embodiment may have functionality for visualization and navigation of a graphical user interface for requesting and displaying information about offers available from multiple offer sources, such as brands, product types, offer lists and so forth, and more particularly, for receiving input from a user interacting through the graphical user interface to request performance of an operation for the offer application and functionality for displaying results received from the offer server 242 after performing the requested operation for the offer application.

Moreover, additional applications may execute on the user client 202 that enable notification of updates of offers in various embodiments through multiple notification channels requested by users. For instance, an email application 210 may function both as an instant or periodic notification channel to receive updates about offers and may also function as a communication channel for a user to request performance of an operation for an offer application. Those skilled in the art may recognize that email messages may function as commands to the offer server 242 to perform any functions supported by the offer server 242. Finally, the messaging application 212 may also serve as an instant or periodic notification channel to receive updates about offers and may also function as a communication channel for a user to request performance of an operation for the offer application. The messaging application 212 may be any type of messaging application including an instant messaging application, a text messaging application such as Simple Message Service (SMS), a chat messaging application, and so forth.

In general, the web browser 204, the offer application 206, the offer application user interface 208, the email application 212, and the messaging application 214 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The marketing client 214 may communicate with one or more messaging servers 220 through a network 240 and may also communicate with one or more offer servers 242 in various embodiments where components of the messaging server 228 may also be present on an offer server 242. The marketing client 214 may be a computer such as computer system 100 of FIG. 1 or another computing device including a mobile device. A web browser 216 may execute on the marketing client 214 and may include functionality for receiving a request to generate a marketing communication, functionality for tagging the marketing communication, and functionality for sending the marketing communication to a user. The web browser 216 may be operably coupled to a tagging application 220 having functionality for tagging the text of a marketing communication to identify and delineate information about an offer occurring with the text of the marketing communication. The web browser 216 may also be operably coupled to marketing database 222 that stores marketing messages 224 that may include offer information 226 for several offers. These marketing messages 224 may be tagged to identify and delineate information about an offer including the offer description, the offer expiration date, a coupon code, and so forth. An email application 218 may also operate on the marketing client 214 having functionality for sending a marketing message 224 to one of more users.

The web browser 216, the email application 210, and the tagging application 220 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The messaging server 228 may be any type of computer system or computing device such as computer system 100 of FIG. 1. The messaging server 228 may support email services for receiving incoming email messages for an email account assigned to the messaging server 228 and storing the email messages for email accounts in a messaging database. In particular, the messaging server 228 may include a mail transport agent 230 which includes functionality to receive email messages for email accounts assigned to the messaging server 228, a mail delivery agent 232 which includes functionality to store the email messages for email accounts assigned to the messaging server 228 in a messaging database, and a messaging agent 234 which includes functionality to receive requests from an email client to retrieve email messages stored in the messaging database for email accounts assigned to the messaging server 228. The messaging server 228 may also be operably coupled to a messaging database 236 that stores email messages 238 for email accounts.

The mail transport agent 230, the mail delivery agent 232, and the messaging agent 234 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The offer server 242 may be any type of computer system or computing device such as computer system 100 of FIG. 1. In general, the offer server 242 may support services for providing promotional offers, offer lists, and for generating offers from marketing communications. In particular, the offer server 242 may include a consumer offer application 244 which includes functionality to provide lists of promotional offers from multiple offer sources, including marketing communications. The consumer offer application 244 may include a brand component 246 that manages brand information for brands, a product type component 248 that manages product type information for product types, an offer component 250 that manages offer information for offers, an offer list component 252 that manages offer list information for offer lists, and a consumer application programming interface (API) 254 that may be invoked to perform operations provided by the consumer offer application 244 including operations performed by the brand component 246 for brands, operations performed by the product type component 248 for product types, and operations performed by the offer list component 252 for offer lists. The consumer API 254 may include an offer application programming interface (API) 256 that may be invoked to perform operations, including operations performed by the offer component 250, for promotional offers from multiple sources.

The consumer offer application 244 may be operably coupled to a database engine 258, a recommendation engine 262, a notification engine 264 and a user profile engine 266. The database engine 258 may provide database services and may include a query processor 260 having functionality to process received queries by retrieving the data from the data server 280 and processing the retrieved data. The recommendation engine 262 may also be operably coupled to the database engine 258 and the notification engine 264. The recommendation engine 262 may provide recommendation services for the various operations of the consumer offer application 244 and may have functionality for receiving requests for recommendations for an operation of the consumer offer application 244, retrieving and ranking results, and returning a list of recommendations for the requested operation of the consumer offer application 244. The notification engine 264 may have functionality for receiving updates to offers, offer lists, and other information for which a user may request notification, and the notification engine 264 may have functionality for sending notification of such updates in various embodiments through multiple notification channels including email application 210 and messaging application 212. The offer server 242 may additionally include a user profile engine 266 that manages user profile information including notification channels assigned to a user.

The offer server 242 may also include a message processor 268 which includes functionality to process marketing messages, an offer extract engine 270 which includes functionality to extract offers from marketing messages, and an offer generating engine 276 which includes functionality to generate offers for loading into the data server storing offers for the online offer service. The offer extract engine 270 may further include a message parser 272 which includes functionality to parse the message and an offer element parser 274 which includes functionality to parse offer elements in the message such as a brand name, an offer headline, a description of the offer, and so forth.

The consumer offer application 244, each of its components, the database engine 258, the recommendation engine 262, the notification engine 264, user profile engine 266, the message processor 268, the offer extract engine 270, each of its components, and the offer generating engine 276 may each be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The offer server 242 may additionally include server storage 278. The database engine 258, the recommendation engine 262, the notification engine 264, the user profile engine 266, the message processor 268, the offer extract engine 270, and the offer generating engine 276 may be operably coupled to server storage 278 that stores information for brands 280, information for product types 282, information for offers 284, information for offer lists 286, information for brand address mapping 288 to identify email addresses associated with particular brands, information for message offer map 288 to identify a message and the offers generated from the message, and information for user profiles 274 including information of notification channels 276.

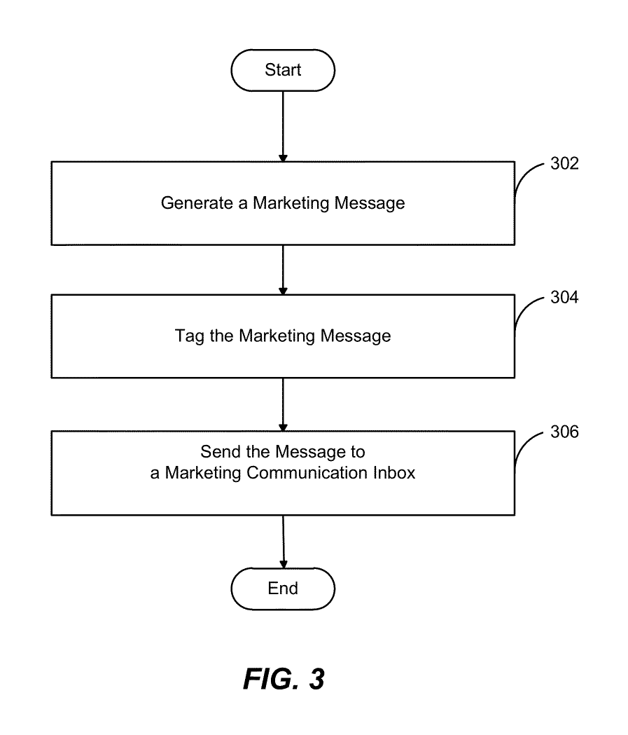

FIG. 3 presents a flowchart generally representing the steps undertaken in one embodiment for sending marketing communications to a marketing communications inbox. At step 302, a marketing communication may be generated. In an embodiment, a web browser executing on a client device such as marketing client 214 may be used to compose a marketing message with one or more promotional offers. The offer may include a Uniform Resource Locator (URL) which may be selected to retrieve a web page with further information about the offer or to accept the offer. In alternative embodiments, the marketing message may be selected from a marketing database of composed marketing messages such as marketing messages 224 with offer information 226 stored in marketing database 222.

At step 304, the marketing message may be tagged. For instance, a tagging application such as tagging application 220 may be used for tagging the text of a marketing communication to identify and delineate information about an offer occurring with the text of the marketing communication. Tags may be inserted to demark each offer occurring with the text of the marketing communication and may further be used to identify and delineate information within an offer including such information as the offer description, the offer expiration date, a coupon code, and so forth. Those skilled in the art will appreciate that an XML-based language may be used for example to encode the marketing message so that offers within it may be parsed by a parser and stored. In an embodiment, the tags may be entered by a user executing the tagging application and inserted in the marketing message. In other embodiments, the tagging application may apply natural language processing to insert tags in the marketing message.

At step 306, the message may be sent to a marketing communication inbox. As used herein, an inbox means a list of email messages received for an email account that are stored for the email account. In an embodiment, an email application such as email application 218 executing on the marketing client 214 may be used to send the marketing message to one or more email accounts with marketing communications inboxes like the email accounts assigned to the messaging server 228. Marketing messages delivered to the messaging server 228 may be stored for email accounts in a messaging database such as messages 238 stored in message database 236. Those skilled in the art will appreciate that such marketing communications may be sent in various embodiments by various messaging applications like email applications, instant messaging applications, and other messaging applications.

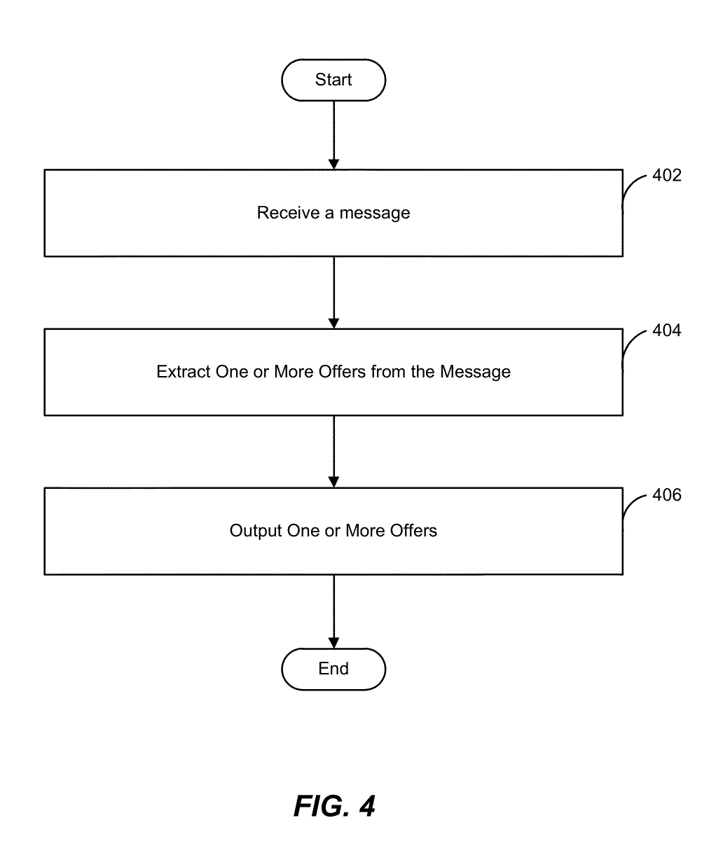

In an embodiment, marketing communications delivered to the messaging server 228 that are stored for email accounts in a messaging database may be periodically processed to extract offers from the marketing communications received. FIG. 4 presents a flowchart generally representing the steps undertaken in one embodiment for processing marketing communication messages to extract offers. At step 402, a message may be received. For example, a marketing message sent from a marketing client 214 may be received by the messaging server 228. In an embodiment, requests may be sent periodically to the messaging server 228 to retrieve new messages delivered and stored for users email accounts. For instance, the message processor 268 may send a request periodically, such as every five minutes, to the message server 228 to retrieve new messages for user email accounts. In another embodiment, the message server 228 may send new messages delivered and stored for user email accounts to the message processor 268.

At step 404, one or more offers may be extracted from the message. In an embodiment, the message processor 268 may invoke the offer extract engine 270 to extract the offers from a marketing message. In various embodiments, the message processor 268 may invoke the offer extract engine 270 to extract offers sent by recognized brands, and yet in other embodiments the message processor 268 may also invoke the offer extract engine 270 to extract offers sent by brands unrecognized by the online offer service. At step 406, one or more offers may be output. For instance, the offers may be saved in storage for later presentation to users of an online offer service in an embodiment. Additionally, notifications of the offers may be sent in various embodiments to users of an online offer service.

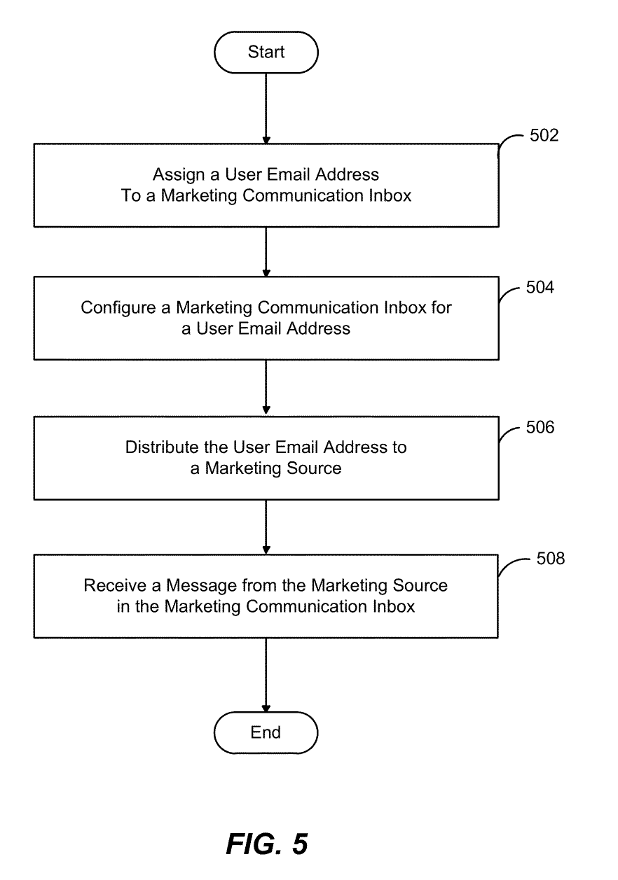

FIG. 5 presents a flowchart generally representing the steps undertaken in an embodiment for receiving a message as described above at step 402 of FIG. 4. At step 502, an email address for a user may be assigned to a marketing communication inbox. At step 504, a marketing communication inbox may be configured for the email address of a user. In an embodiment, the marketing communication inbox may be configured by assigning email settings and notification settings. At step 506, the email address of a user may be distributed to one or more marketing sources. For instance, a user may provide the email address of their marketing communication inbox when providing contact information to a marketing organization or representative. This may occur during online registration on websites, mail-in registration for products or services, in-person registration in stores, and so forth. In an embodiment, the user may request during configuration of their marketing communications inbox that the address of their marketing communications inbox be sent by the online offer service generally to marketing organizations or selectively to marketing organizations representing particular brands.

At step 508, a message may be received from a marketing source in the marketing communication inbox. In an embodiment, messages accepted for delivery to the marketing communications inbox may be limited to those sent by email addresses representing marketing organizations requested or identified by the user. In other embodiments, messages may be accepted for delivery to the marketing communications inbox from email addresses representing marketing organizations not requested or identified by the user.

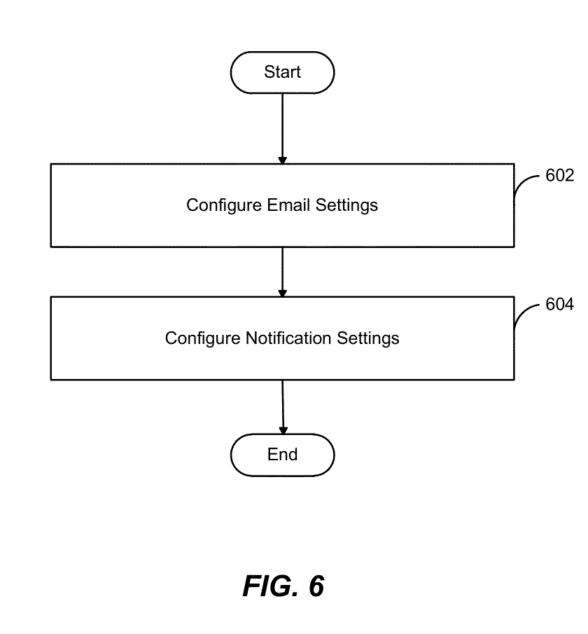

FIG. 6 presents a flowchart generally representing the steps undertaken in an embodiment for configuring a marketing communication inbox. At step 602, email settings may be configured. For example, forwarding of emails to a personal email address may be selected for forwarding marketing communications to another email inbox of the user. At step 604, notification settings may be configured such as the frequency for receiving notifications of new offers identified in marketing communications. In an embodiment, a newsletter may be sent to notify users of new offers identified in marketing communications. Those skilled in the art will appreciate the email settings may include a setting to forward offers as specified by the notification settings which may specify a frequency of notification and notification channels such as an instant message or alert sent for display by a variety of applications to a computing device such as a mobile phone or a computer. For example, the notification of new offers may displayed by such applications as a messaging application including text messaging, a toolbar with notification pop-up messages, a conferencing application with notification pop-up messages, and so forth.

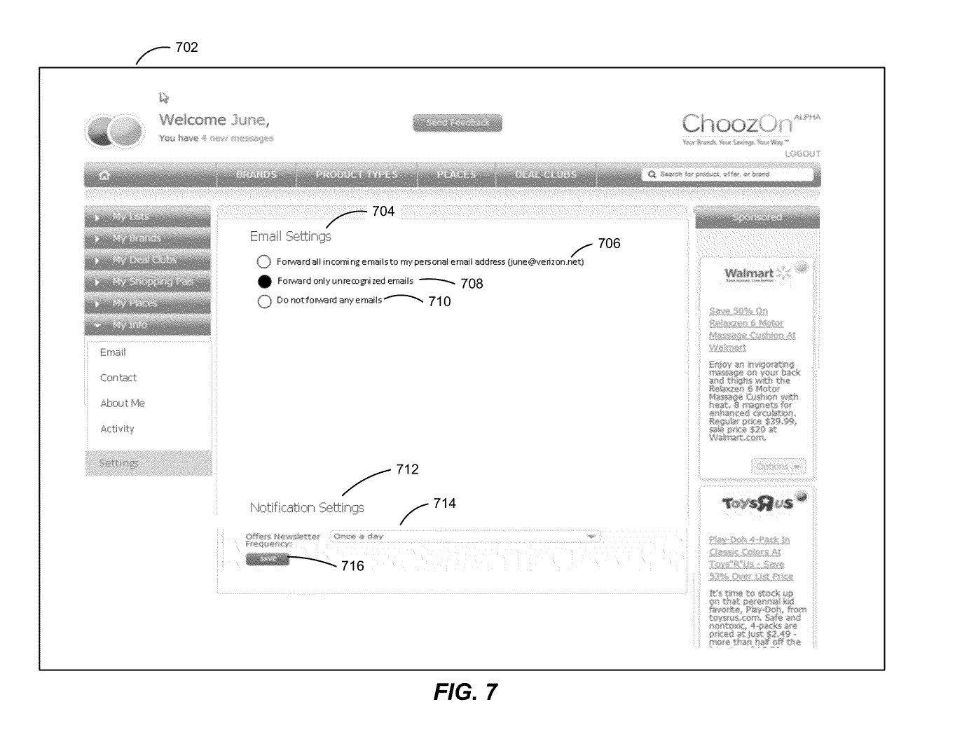

FIG. 7 presents an exemplary illustration generally representing a screen of a graphical user interface with user input controls to configure a marketing communication inbox. The screen 702 in FIG. 7 shows the window of a graphical user interface for a web browser executing an offer application to configure settings for a user's marketing communication inbox. In an embodiment, the window of the graphical user interface for the web browser executing the offer application 702 may display user interface elements for configuring email settings 704 and notification settings 712.

For configuring email setting 704, user input element 706 may be selected to forward incoming emails to a personal email address, user input element 708 may be selected to forward emails from unrecognized addresses, and user input element 710 may be selected to not forward emails. For configuring notification settings 712, dropdown menu 714 may be selected to set the frequency of notification such as once a day, once a week, once a month, and so forth. Also illustrated in FIG. 7 is input button 716 labeled “Save” that may be selected to persistently save the configured email settings and the configured notification settings. As used herein, an element in a graphical user interface means any graphical user interface object such as a window, an application window, a dialog box, a message box, a toolbar, a control, a button, a menu, and so forth. In addition to a graphical user interface object such as a window, an element may also include a pane or frame of a window.

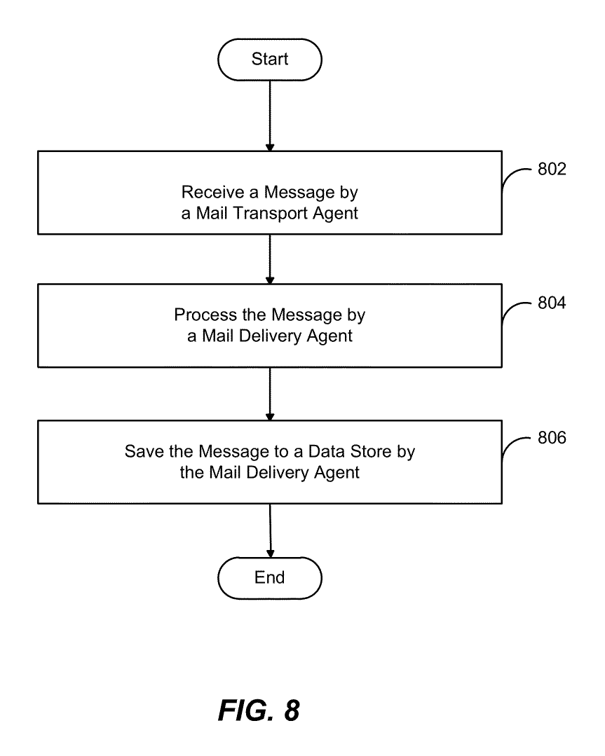

FIG. 8 presents a flowchart generally representing the steps undertaken in an embodiment for processing a marketing communication message received for a marketing communication inbox. At step 802, a message may be received by a mail transport agent such as mail transport agent 230 executing on messaging server 228 described above in conjunction with FIG. 2. The message may be passed for delivery to a mail delivery agent in an embodiment. At step 804, the message may be processed by a mail delivery agent such as mail delivery agent 232 described in conjunction with FIG. 2. For instance, the message may be parsed to extract header information and a message body. At step 806, the message may be saved in a data store like the messaging database 236 by the mail delivery agent. For instance, the mail delivery agent may store the header information, message body, and attachments from the incoming message. The mail delivery agent may store the message in various embodiments in a plain text version as well as the Hypertext Markup Language (HTML) version. In addition to header information and the message body, relevant metadata may also be stored such as the sender of the message, the subject of the message, the recipient(s) of the message, a date and time of receiving the message, and so forth.

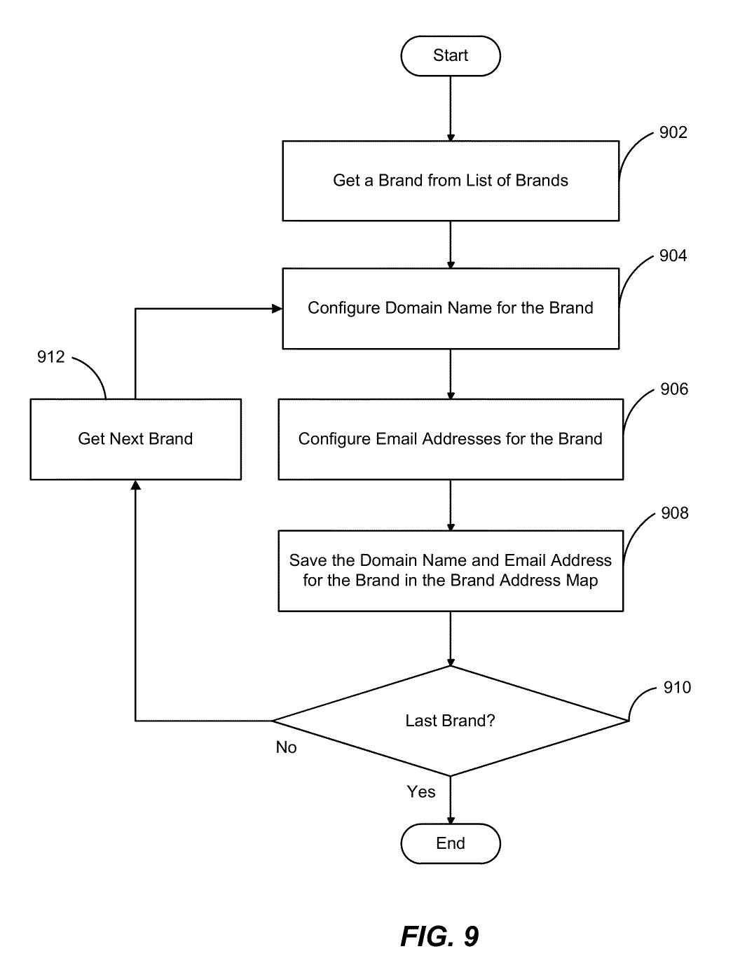

FIG. 9 presents a flowchart generally representing the steps undertaken in an embodiment for configuring a brand address map that may be used to identify a recognized brand. At step 902, a brand may be obtained from a list of recognized brands. The brand may be represented by a name or a brand identifier. In various embodiments, a new brand not on the list of recognized brands may be obtained by entering the brand name. In step 904, a domain name may be configured for the brand. In an embodiment, the association of the domain name with a brand identifier may be entered into a record for saving in a brand address map like brand address map 288 described in conjunction with FIG. 2. Such a domain name may be a hostname that identifies an Internet Protocol (IP) resource such as a web site. Those skilled in the art will appreciate that a brand may have one or more domain names. At step 906, email addresses may be configured for the brand. The email address may be saved in an embodiment in the record with the association of the domain name with the brand identifier for saving in a brand address map. At step 908, the domain name and email address associated with the brand may be saved in a brand address map like brand address map 288 described in conjunction with FIG. 2. In an embodiment, a record with an association of the domain name and email address with a brand identifier may be saved in a brand address map.

At step 910, it may be determined whether the last brand has been configured. For instance, it may be determined in an embodiment whether the last brand in the list of recognized brands has been configured. If it may be determined that the last brand has been configured at step 910, then processing may be finished. Otherwise, the next brand may be obtained at step 912 and processing may continue at step 904 where a domain may be configured for the brand. Advantageously, incoming marketing messages may be selectively processed according to recognized brands and may be filtered according to interests of a user for presentation to the user. As a result, relevant offers may be extracted from incoming marketing messages and presented to a user, alleviating inundation of overwhelming marketing messages.

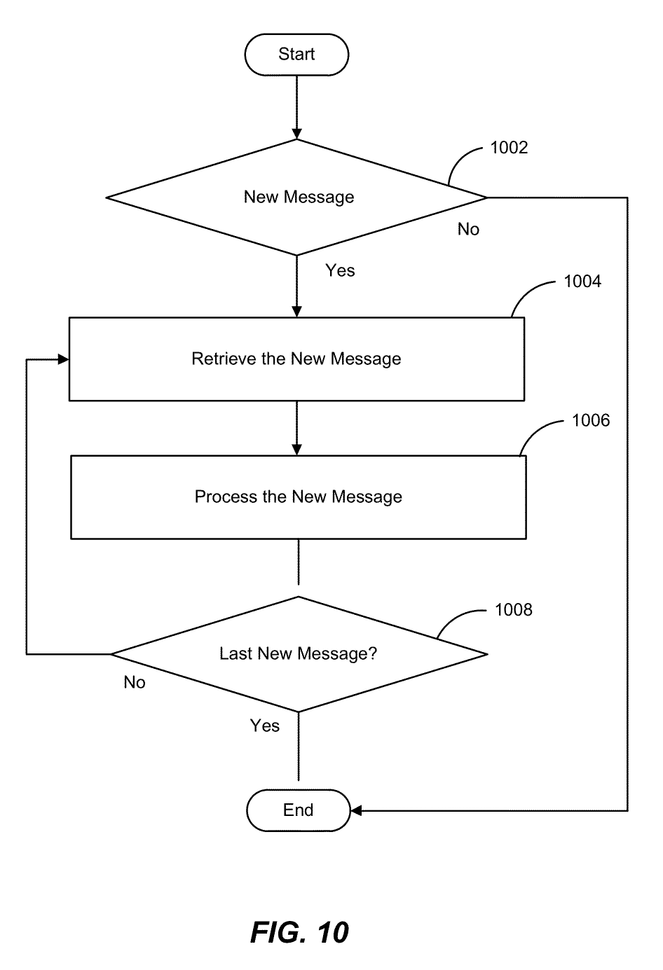

FIG. 10 presents a flowchart generally representing the steps undertaken in an embodiment for processing a new marketing communication message. At step 1002, it may be determined whether a new message may be received. In an embodiment, the message processor 268 executing on offer server 242 in FIG. 2 may periodically send a request to messaging agent 234 executing on messaging server 228 for any new message received and stored in messaging database 236. In various embodiments, the request sent may be for new messages received since the previous periodic request was sent for new messages. If it is determined that there is no new message received, then processing may be finished.

If it is determined at step 1002 that a new message is received, then a new message may be retrieved at step 1004. In an embodiment, the messaging agent 234 may retrieve a new message received and stored in messaging database 236 and send it to the message processor 268. In an alternate embodiment, new messages received by the messaging server 228 may be sent as they are received or periodically from the messaging server 228 to the message processor 268. At step 1006, the message may be processed. Those skilled in the art will appreciate that processing the message may include extracting a description of an offer in the message for listing as the subject of an offer presented in a marketing communication inbox to a user and may further include extracting offer information for each offer in the message to generate offers from the message for storage. In various embodiments, a description of one offer in the email message may be extracted and shown in an email newsletter. At step 1008, it may be determined whether the last new message was retrieved. If so, then processing may be finished. Otherwise, another new message may be retrieved at step 1004 and processing may continue until the last new message is retrieved.

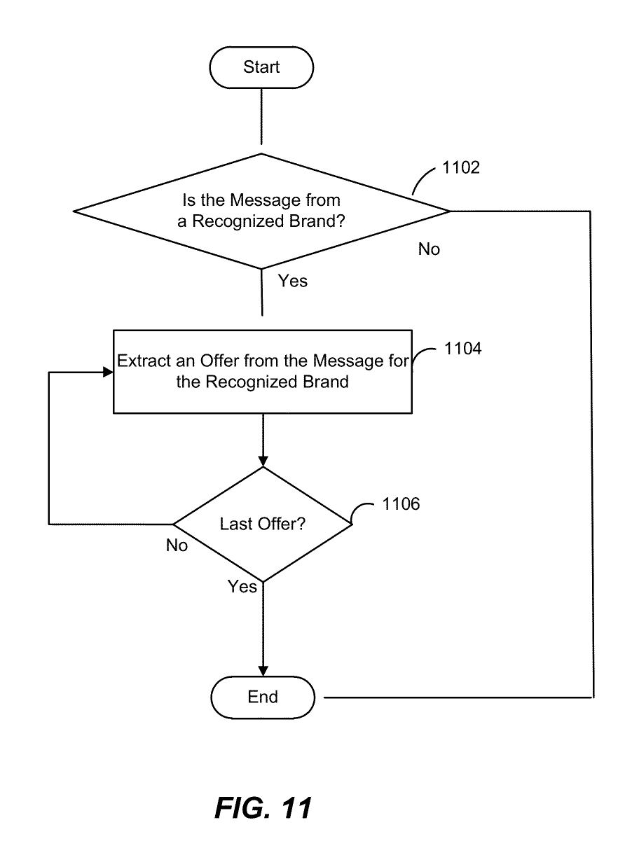

FIG. 11 presents a flowchart generally representing the steps undertaken in another embodiment for processing a new marketing communication message. In an embodiment, the steps in FIG. 11 may be executed by the message processor 268 described in conjunction with FIG. 2. At step 1102, it may be determined whether the message is from a recognized brand. In an embodiment, the domain or the email address of the sender of the message may be checked against the domain and email addresses in the brand address map to determine if the message was sent from a domain or email address associated with a brand. If it is determined that the message is not from a recognized brand, processing may be finished. Otherwise, if it is determined that the message is from a recognized brand at step 1102, then an offer may be extracted from the message for the recognized brand at step 1104.

In an embodiment, a description of one offer in the email message may be extracted and shown in an email newsletter without extracting additional information about the offer or other offers in the email message. For instance, the headline of the message may be extracted as the subject of the offer and the first 120 characters in the message body may be extracted as a description of the offer. In other embodiments, additional offer information may be extracted for each offer in the marketing email, and an offer may be generated from the offer information extracted for each offer and stored. At step 1106, it may be determined whether the last offer was extracted. If so, then processing may be finished. Otherwise, another offer may be extracted from the message for the recognized brand at step 1004 and processing may continue until the last offer is extracted.

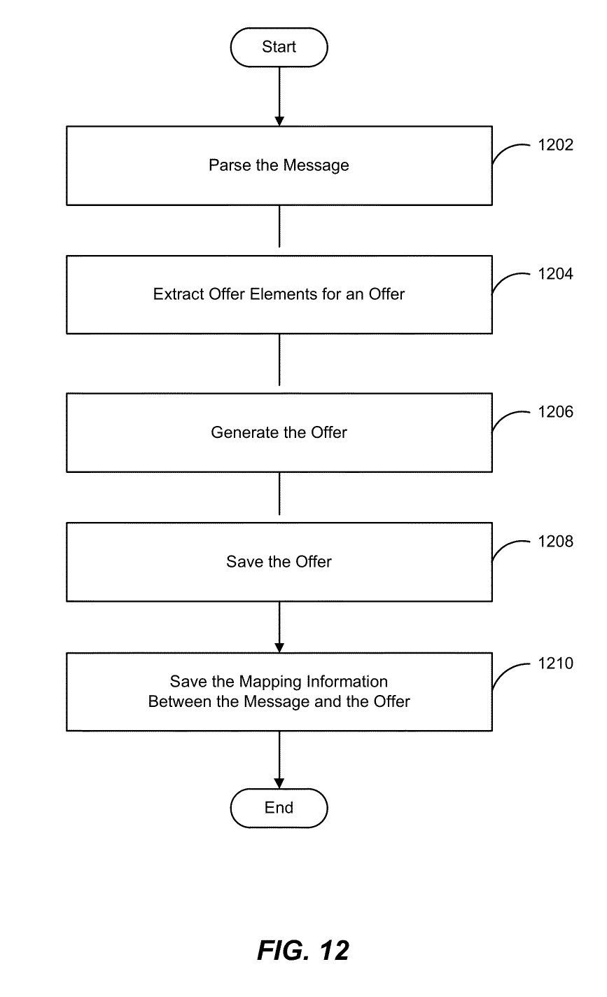

FIG. 12 presents a flowchart generally representing the steps undertaken in one embodiment for extracting one or more offers from a marketing communication message. In an embodiment, steps 1202 and 1204 in FIG. 12 may be executed by the offer extract engine 270 described in conjunction with FIG. 2, and steps 1206, 1208 and 1210 in FIG. 12 may be executed by the offer generating engine 276 described in conjunction with FIG. 2. At step 1202, a message may be parsed. In an embodiment, the offer extract engine 270 may be invoked by the message processor 268 in order to extract offers from a message, and the offer extract engine 270 may invoke message parser 272 to parse the message structure to identify header components, message metadata, message body, attachment, and so forth. At step 1204, offer elements may be extracted from the message for an offer. In an embodiment, the offer extract engine 270 may invoke the offer element parser 274 to extract offer elements for an offer, including the brand, headline text, description, and content.

At step 1206, an offer may be generated. In an embodiment, the offer extract engine 270 may invoke the offer generating engine 276 to generate an offer from the offer elements extracted. In various embodiments, the subject of the message may be extracted as the headline of the offer and the first 120 characters in the message body may be extracted as a description of the offer. In other embodiments, an offer may be generated from additional offer elements extracted for an offer, including headline text, description text, URL text, brand name, expiration date, coupon code and so forth.

At step 1208, the offer may be saved. In an embodiment, the offer may be persistently stored in storage such as offer 284 in server storage 278 described in conjunction with FIG. 2. In another embodiment, the offer may be stored as a message headline and message body. At step 1210, mapping information associating the message with the offer generated may be saved. In an embodiment, the offer generating engine 276 may create an entry with an offer identifier associated with a message identifier in a data table such as the message offer map 290 described in conjunction with FIG. 2. An entry in the message offer map 290 may generally include fields such as a message identifier, an offer identifier, and message status.

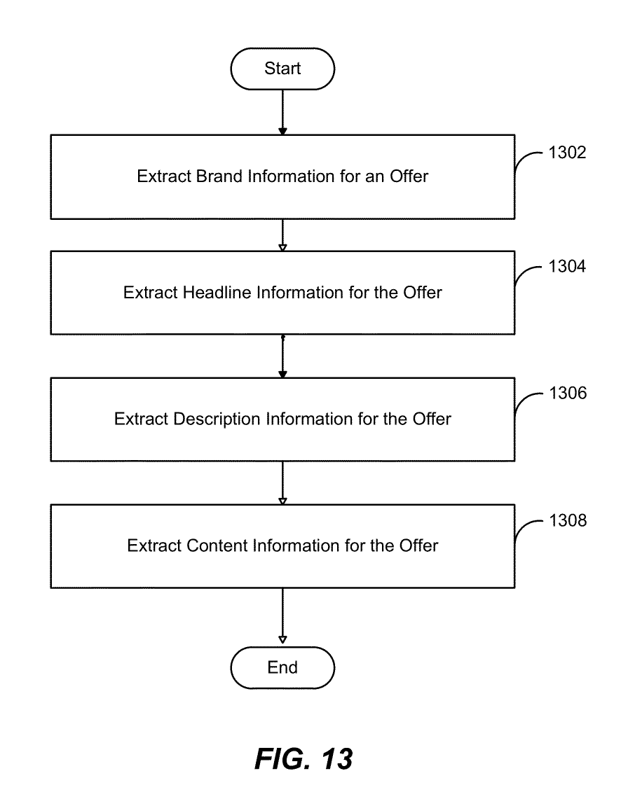

FIG. 13 presents a flowchart generally representing the steps undertaken in an embodiment for extracting offer elements for an offer. In an embodiment, step 1302 may be executed by the message processor 268 described in conjunction with FIG. 2, and steps 1304, 1306 and 1308 may generally be executed by the offer extract engine 270 described in conjunction with FIG. 2. At step 1302, brand information may be extracted for an offer. In an embodiment, the text of a brand name for a brand identifier appearing in the brand address map 288 may be identified in the message, or the brand may be identified from either the domain name or the email address of the sender of the message that appear for recognized brands in the brand address map 288. At step 1304, headline information may be extracted for an offer. In an embodiment, the headline information may be extracted from the subject field of the message for instance. At step 1306, description information may be extracted for an offer. In an embodiment, the first 120 characters in the message body may be extracted as the description information of the offer. And at step 1308, content information may be extracted for an offer. For instance, the message body may be extracted from the message as the content information of an offer in an embodiment.

Those skilled in the art will appreciate that in various embodiments, the messages may be tagged to identify offer elements appearing in the message. For instance, a different tag or identifier may be associated with each different offer element that may delineate the information of the offer element to be extracted. In other embodiments, natural language processing may be used to identify offer elements.

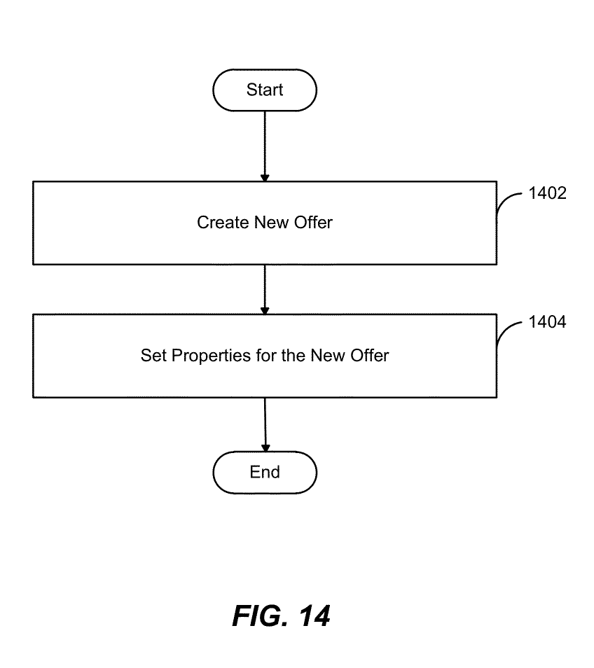

FIG. 14 presents a flowchart generally representing the steps undertaken in an embodiment for generating a new offer. At step 1402 a new offer may be created, and then properties may be set for the new offer at step 1402. In an embodiment, the offer generating engine 276 described in conjunction with FIG. 2 may create an instance of the new offer or an entry in an offer table and then set properties of the offer. Such properties for an offer may include a headline of the offer, a description which may be limited to 120 characters summary of the offer, a detailed description of the offer, a URL address of the offer, an expiration date of the offer, an activation date of the offer, a creation date of the offer, a date when the offer was last updated, a publication status indicating whether the offer was published, a coupon code for the offer, an image associated with the offer, and so forth.

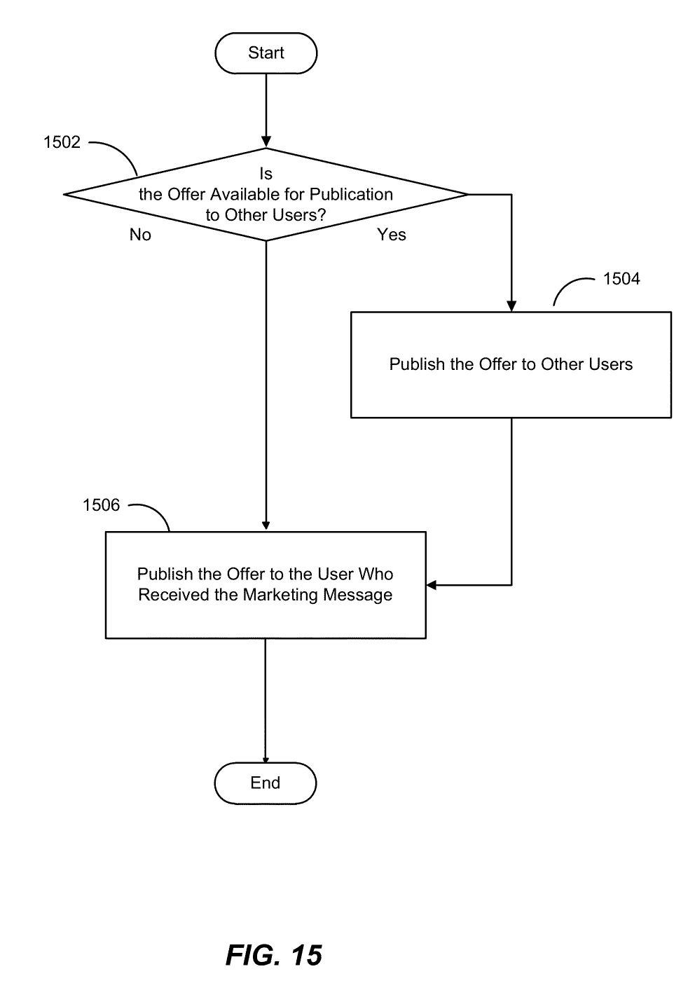

FIG. 15 presents a flowchart generally representing the steps undertaken in an embodiment for publishing a new offer extracted from a marketing communication message. At step 1502, it may be determined whether the offer is available for publication to other users in addition to the user who received the marketing message from which the offer was extracted. In an embodiment, the offer extracted from the user's marketing communication inbox may only be visible to the user who received the marketing message, or the offer may be shared with the user's shopping pals, or the offer may be published and visible for other users in the online offer service. If it may be determined at step 1502 that the offer is available for publication to other users, then the offer may be published and visible for other users in the online offer service at step 1504, and the offer may also be published for the user who received the marketing message at step 1506. If it may be determined at step 1502 that the offer is not available for publication to other users, then the offer may be published and visible only for the user who received the marketing message at step 1506. The publication of the offer may occur through various notification channels associated with a particular user, including but not limited to web browser 204, email application 210, and messaging application 212.

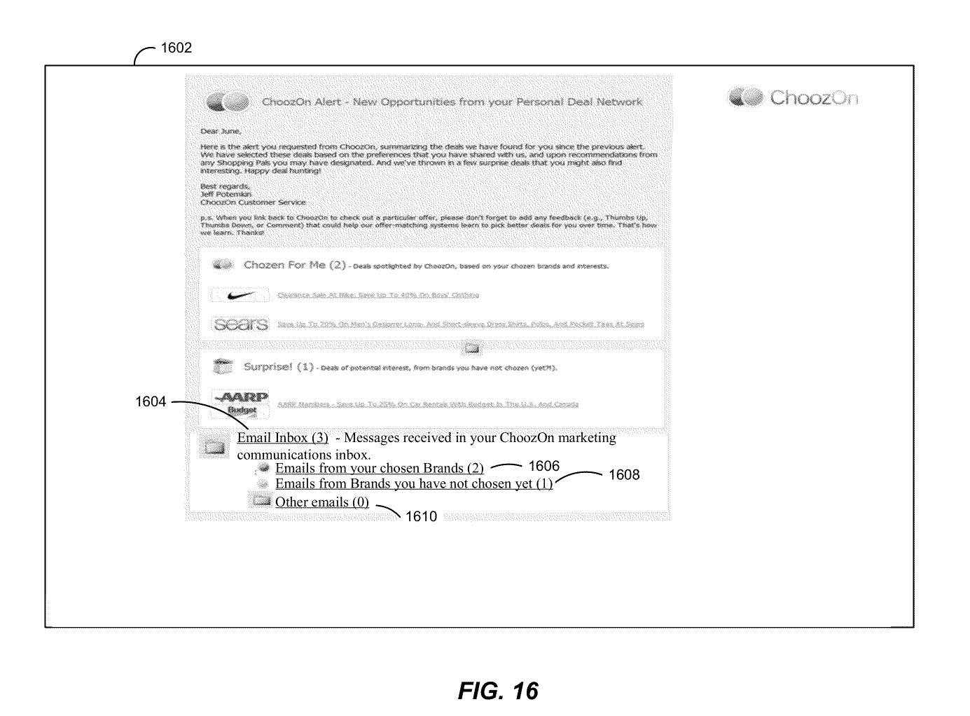

FIG. 16 presents an exemplary illustration in an embodiment generally representing a screen of a graphical user interface displaying notification of new marketing messages received in a marketing communication inbox with user input controls to read the new marketing messages in the marketing communication inbox. The screen 1602 in FIG. 16 shows the window of a graphical user interface for a web browser executing an offer application displaying an alert notification that includes new marketing messages received in a marketing communication inbox with user input controls to read the new marketing messages in the marketing communication inbox. In an embodiment, the window of the graphical user interface for the web browser executing the offer application 1602 may display notification information under the heading “Email inbox (3)” 1604 as illustrated in FIG. 16 about new marketing messages received in a marketing communication inbox in different categories. For instance, FIG. 16 illustrates one category with the descriptive text, “Emails from your chosen Brands (2)” 1606, another category with the descriptive text, “Emails from Brands you have not chosen yet (1) 1608, and a third category with the descriptive text, “Other emails(0)” 1610. Note that a count of new messages appears in parenthesis at the end of the descriptive text of each category. Conveniently, the descriptive text of each category may be the text of a hyperlink as illustrated in FIG. 16 selectable as user interface elements for reading the new marketing messages in a particular category.

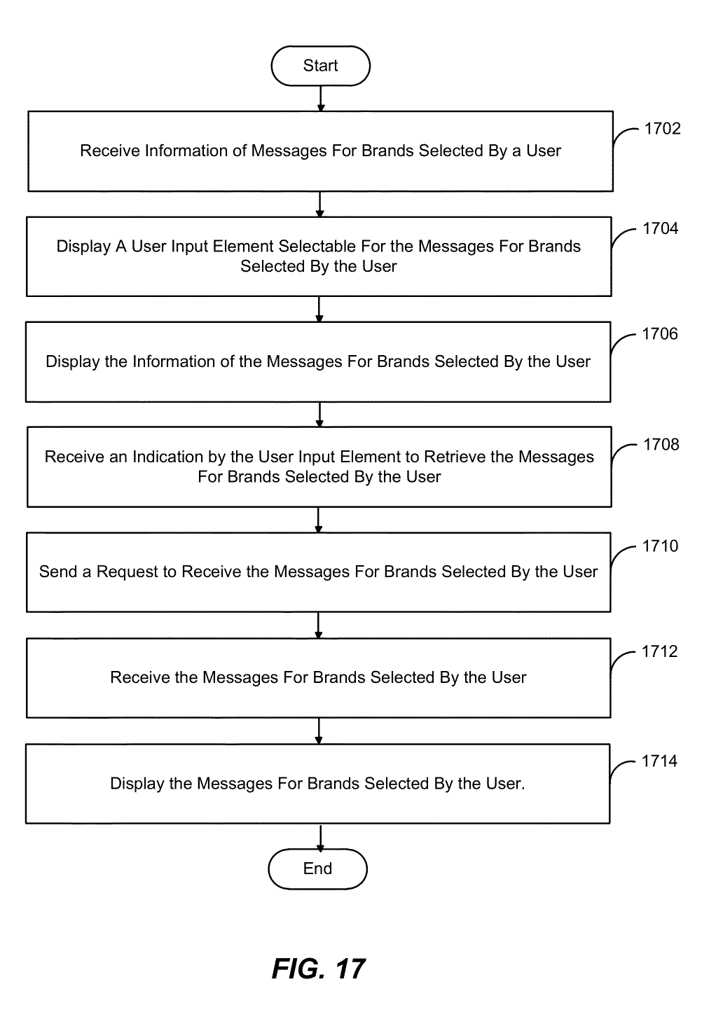

FIG. 17 presents a flowchart generally representing the steps undertaken in one embodiment with a graphical user interface for displaying messages received in a marketing communication inbox for brands selected by a user. At step 1702, information about messages in a marketing communication inbox may be received. In an embodiment, a user client 202 described in conjunction with FIG. 2 may receive information about the messages in a marketing communication inbox. In various embodiments, the information received may include a count of new messages for brands selected by the user and may include a count of new messages for brands that are not selected by the user. In other embodiments, the information may include a count of new messages for both brands that are selected by the user and brands that are not selected by the user. Such may be the case for instance in the illustration of FIG. 16 described above that includes a count of emails with the descriptive text, “Emails from your chosen Brands (2)” 1606 and also a count of emails with the descriptive text, “Emails from Brands you have not chosen yet (1) 1608. Those skilled in the art will appreciate that other information may be received that is related to the messages for brands selected by a user, including without limitation, names of brands selected by the user.

At step 1704, a window of a graphical user interface may be displayed on a computing device with a user input element selectable for the messages for brands selected by the user. At step 1706, information about the messages for brands selected by the user may be displayed in a window of the graphical user interface. In an embodiment, the user input element selectable for the messages for brands selected by the user may be a hyperlink and the text of the hyperlink may be the information displayed about the messages for brands selected by the user. At step 1708, an indication may be received by the user input element to retrieve the messages for brands selected by the user. Accordingly, a request may be sent at step 1710 to receive the messages for brands selected by the user. The messages for brands selected by the user may be received at step 1712 and may be displayed at step 1714.

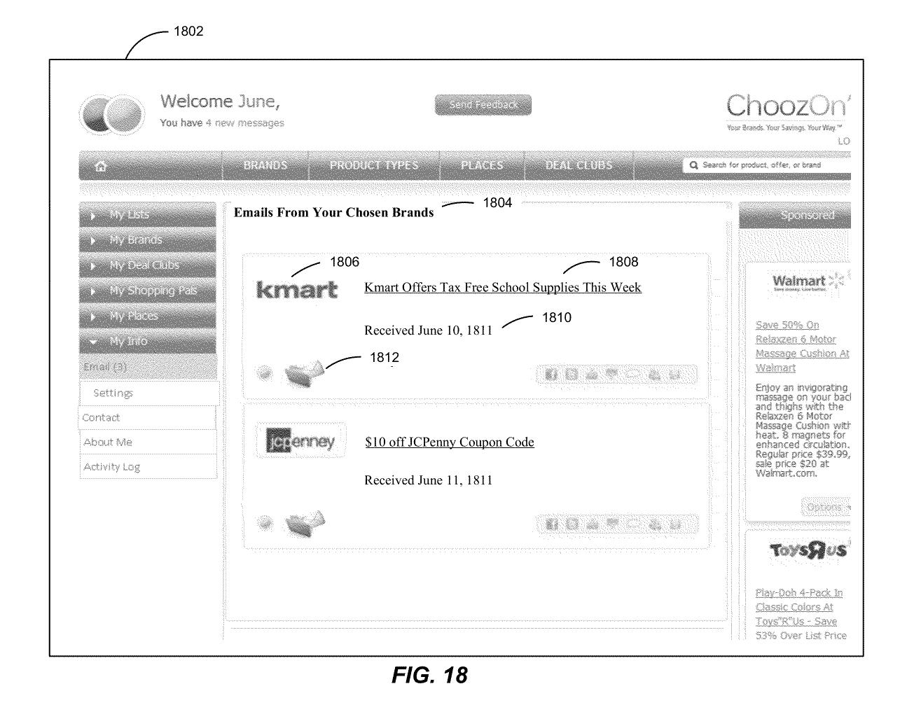

FIG. 18 presents an exemplary illustration in an embodiment generally representing a screen of a graphical user interface displaying offers extracted from marketing messages received in a marketing communication inbox for brands selected by a user. For instance, the screen illustrated in FIG. 18 may be displayed when a hypertext link is selected like the hypertext link illustrated in FIG. 16 with the descriptive text, “Emails from your chosen Brands (2)” 1606. The screen 1802 in FIG. 18 shows the window of a graphical user interface for a web browser executing an offer application displaying offer extracted from marketing messages received in a marketing communication inbox for brands selected by a user. In an embodiment, the window of the graphical user interface for the web browser executing the offer application 1802 may display offers extracted from marketing messages under the heading “Emails From Your Chosen Brands” 1804 as illustrated in FIG. 18. The information displayed for an offer as illustrated in FIG. 18 may include an icon depicting the trademark of a brand such as kmart 1806, the title of an offer 1808, a timestamp when the message was received from which the offer was extracted 1810, and an icon indicating the offer was extracted from a marketing communication message 1812, and so forth. A user may select the title of the offer 1808 to reveal the detailed description of the offer, retrieve the source message, jump to the Universal Resource Locator (URL) where the offer may be accepted, or navigate to any URL linked by 1808 in various embodiments.

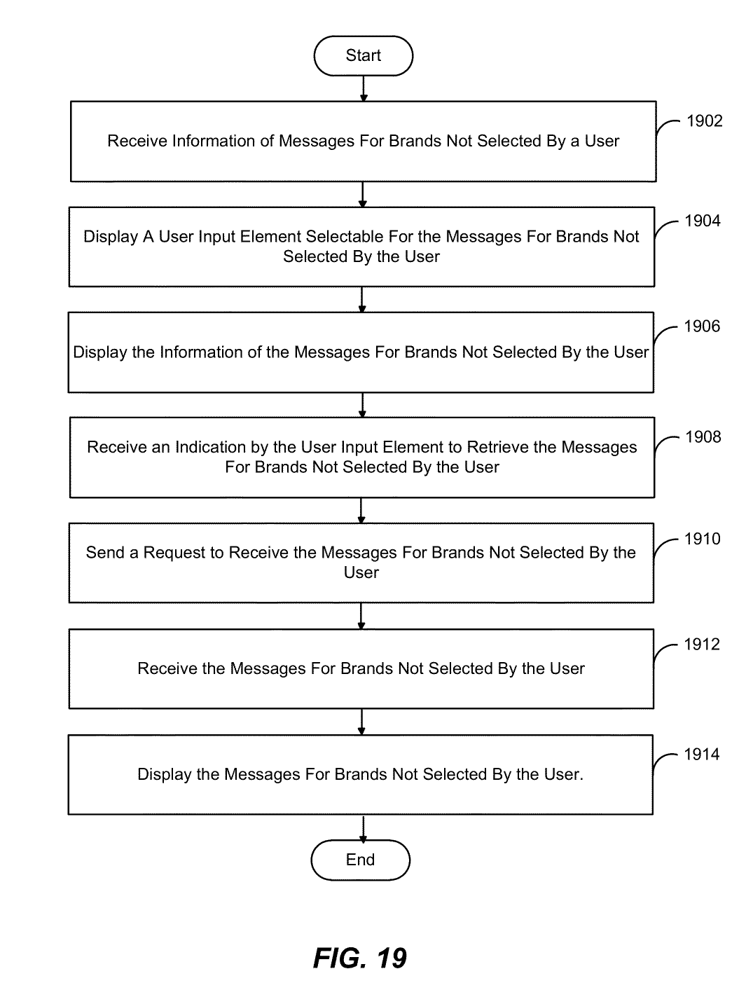

FIG. 19 presents a flowchart generally representing the steps undertaken in one embodiment with a graphical user interface for displaying messages received in a marketing communication inbox for brands not selected by a user. At step 1902, information about messages in a marketing communication inbox for brands not selected by a user may be received. In an embodiment, a user client 202 described in conjunction with FIG. 2 may receive information about the messages in a marketing communication inbox for brands not selected by a user. In various embodiments, the information received may include a count of new messages for brands not selected by the user and may include a count of new messages for brands that are selected by the user. In other embodiments, the information may include a count of new messages for both brands that are not selected by the user and brands that are selected by the user. Such may be the case for instance in the illustration of FIG. 16 described above that includes a count of emails with the descriptive text, “Emails from Brands you have not chosen yet (1) 1608 and also a count of emails with the descriptive text, “Emails from your chosen Brands (2)” 1606. Those skilled in the art will appreciate that other information may be received that is related to the messages for brands not selected by a user, including without limitation, names of brands selected by the user.

At step 1904, a window of a graphical user interface may be displayed on a computing device with a user input element selectable for the messages for brands not selected by the user. At step 1906, information about the messages for brands not selected by the user may be displayed in a window of the graphical user interface. In an embodiment, the user input element selectable for the messages for brands not selected by the user may be a hyperlink and the text of the hyperlink may be the information displayed about the messages for brands selected by the user. At step 1908, an indication may be received by the user input element to retrieve the messages for brands not selected by the user. Accordingly, a request may be sent at step 1910 to receive the messages for brands not selected by the user. The messages for brands not selected by the user may be received at step 1912 and may be displayed at step 1914.

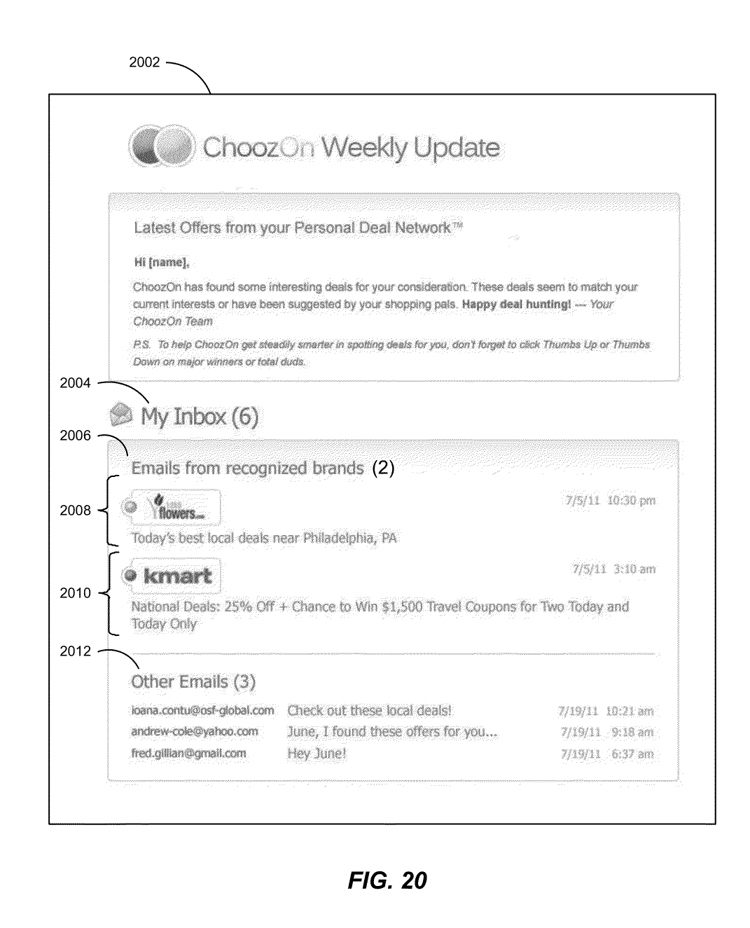

Those skilled in the art will appreciate that there may be still other embodiments generally representing a screen of a graphical user interface displaying notification of new marketing messages received. For example, information about one of more offers extracted from the marketing message may also be displayed. FIG. 20 presents an exemplary illustration in an embodiment generally representing a screen of a graphical user interface displaying notification of new marketing messages received in a marketing communication inbox and one of more offers extracted from the marketing message. The screen 2002 in FIG. 20 shows the window of a graphical user interface for a web browser executing an offer application displaying a notification that includes one or more offers extracted from new marketing messages received in a marketing communication inbox. In an embodiment, the window of the graphical user interface for the web browser executing the offer application 2002 may display notification information about new marketing messages received in a marketing communication inbox under the heading “My Inbox (6)” 2004 in two categories. For instance, FIG. 20 illustrates notification information for one category with the descriptive text, “Emails from recognized brands” 2006, and notification information for another category with the descriptive text, “Other Emails(3)” 2012. Note that one or more offers extracted from the marketing messages such as the emails from recognized brands may also be displayed. For instance, an offer from 1-800 flowers.com 2008 and an offer from kmart 2010 are displayed under the descriptive text, “Emails from recognized brands” 2006. Also note that the descriptive text of each offer may be the text of a hyperlink as illustrated in FIG. 20 selectable as user interface elements for reading the new marketing messages from which the offers were extracted.

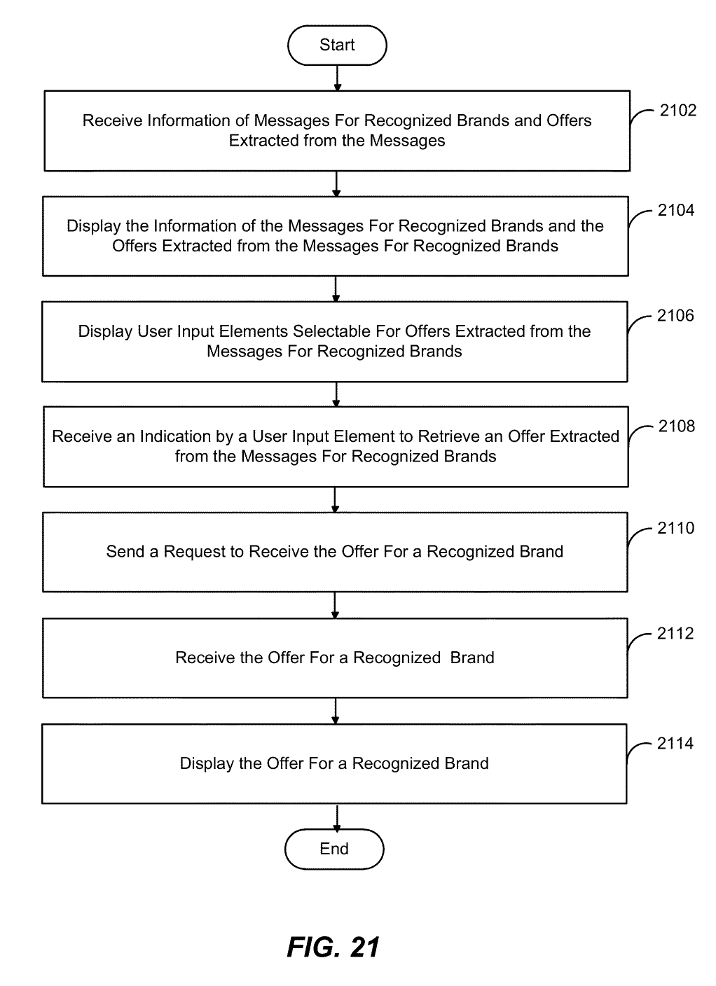

FIG. 21 presents a flowchart generally representing the steps undertaken in one embodiment with a graphical user interface for displaying offers and their related information extracted from the messages for recognized brands. At step 2102, information about messages for recognized brands in a marketing communication inbox may be received that includes information about offers extracted from the messages. In an embodiment, a user client 202 described in conjunction with FIG. 2 may receive information about the messages for recognized brands in a marketing communication inbox. In various embodiments, the information received may include a count of new messages for recognized brands and may include one or more offers extracted from the marketing communication messages for the recognized brands. Such may be the case for instance in the illustration of FIG. 20 described above that includes a count of emails with the descriptive text, “Emails for recognized brands (2)” 2006 and also one or more offers like offers 2008 and 2010 extracted from the marketing communication messages for the recognized brands. Those skilled in the art will appreciate that other information may be received that is related to the messages for recognized brands, including without limitation, names of the recognized brands.

At step 2104, information about the messages for recognized brands and the offers extracted from the messages may be displayed in a window of the graphical user interface. At step 2106, a window of a graphical user interface may be displayed on a computing device with user input elements selectable for the offers extracted from the messages for recognized brands. In an embodiment, a user input element selectable for an offer extracted from a message for a recognized brand may be a hyperlink and the text of the hyperlink may be the information displayed about the offer extracted from message for the recognized brand. At step 2108, an indication may be received by a user input element to retrieve an offer extracted from the messages for recognized brands. Accordingly, a request may be sent at step 2110 to receive the offer for a recognized brand. The offer for a recognized brand may be received at step 2112 and may be displayed at step 2114. Those skilled in the art will appreciate that the message from the inbox that includes the offer may be retrieved and displayed in an embodiment, or an offer generated from the message may instead be retrieved and display in another embodiment.

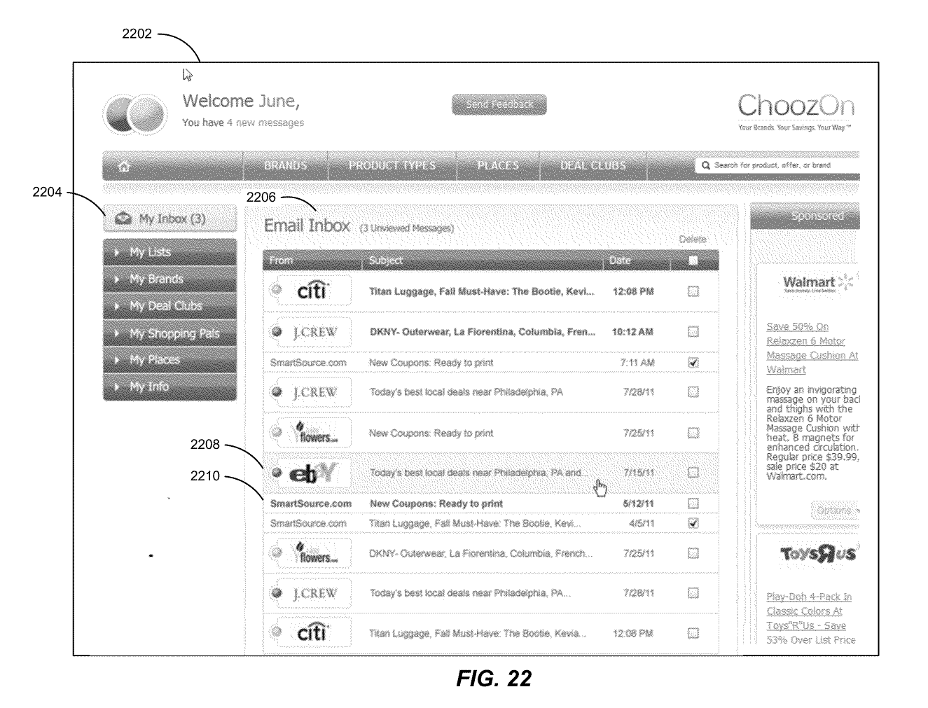

Information about offers extracted from the messages may also be displayed and read from the marketing communication inbox. FIG. 22 presents an exemplary illustration in an embodiment generally representing a screen 2202 of a graphical user interface displaying information about offers for both recognized brands and unrecognized brands that are extracted from marketing messages received in a marketing communication inbox. The screen 2202 in FIG. 22 illustrates a button labeled “My Inbox” 2204 that is selected to display messages received in a marketing communication inbox. In an embodiment, the messages may be displayed as illustrated in a pane under the heading “Email Inbox (3 unviewed messages)” where information about offers extracted from the messages include from which brand the offer originates, the subject of the offer which may be the headline extracted from the message, and date the message was received. Note that the information about an offer that was extracted from a message originating from a recognized brand may be denoted by a trademark for the brand such as offer 2208. Information about an offer extracted from a message originating from an unrecognized brand may also be displayed like offer 2210 with the name of the sender of the message instead of the trademark of the brand.

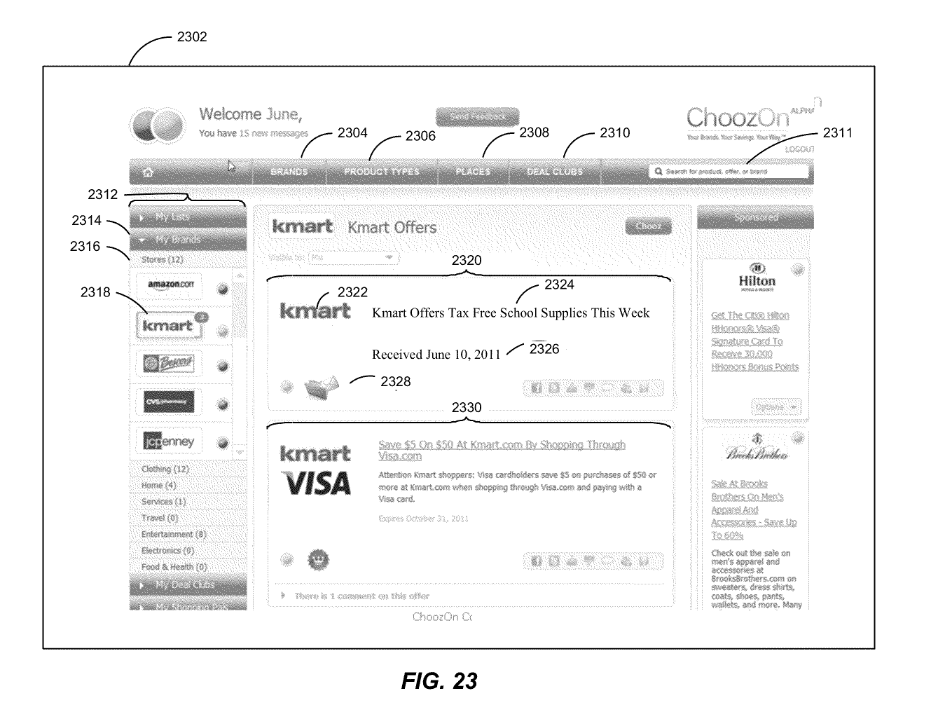

FIG. 23 presents an exemplary illustration in an embodiment generally representing a screen of a graphical user interface displaying offers for a brand that includes offers extracted from marketing messages received in a marketing communication inbox for the brand. The screen 2302 in FIG. 23 shows the window of a graphical user interface for a web browser executing an offer application displaying offers for a brand that includes an offer extracted from a marketing message received in a marketing communication inbox for the brand. In an embodiment, the window of the graphical user interface for the web browser executing the offer application may display user interface elements for various offer sources such as a dropdown menu for brands 2304, a dropdown menu for product types 2306, a button for places 2308, a button for deal clubs 2310, a text input box 2311 for entering a search string, and so forth. Further illustrated within the window of the graphical user interface for the web browser executing the offer application is a personalization pane 2312 which may display user interface elements for navigating among various offer sources personalized by a user of the offer application, such as a dropdown menu for My Brands 2314, a scrollable list of labeled buttons representing Stores 2316 within My Brands 2314 that includes the button for a store labeled “kmart” 2318. FIG. 23 illustrates the button for the store labeled “kmart” 2318 as selected for displaying offers from Kmart. And also illustrated in FIG. 23 is a list of offers from Kmart, including offer 2320 and offer 2330, are displayed adjacent to the personalization pane 2312. Offer 2320 represents an offer extracted from a marketing message received in a marketing communication inbox for the brand Kmart, and offer 2330 represents an offer retrieved from the server storage 278 for the brand Kmart that was entered into the server storage 278 through an administrative interface. Note that the information displayed for an offer 2330 extracted from a marketing message received in a marketing communication inbox may include an icon depicting the trademark, name or symbol of the brand such as kmart 2322, a title of the offer 2324, a date when received 2326, and an icon 2328 representing that the offer originated from a message received in a marketing communication inbox.

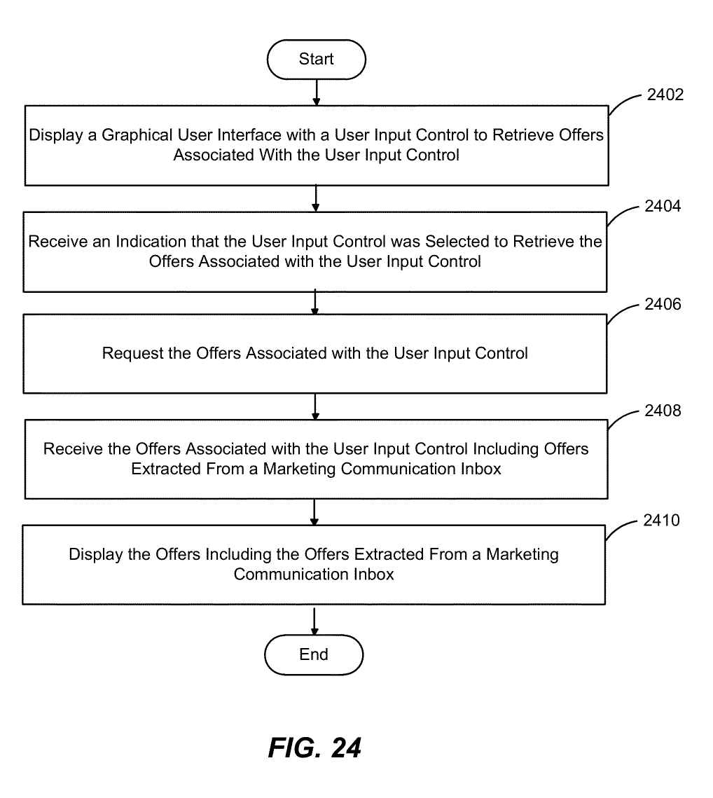

In general, an offer extracted and generated from a marketing message may be stored in persistent storage and may be accessible for search and retrieval in an offer service through a variety of user interfaces. For instance, such an offer may be retrieved and displayed during browsing of a particular brand or product category. FIG. 24 presents a flowchart generally representing the steps undertaken in one embodiment with a graphical user interface for retrieving and displaying offers, including offers extracted from a marketing message in a marketing communication inbox. At step 2402, a window of a graphical user interface may be displayed on a computing device with a user input control selectable to retrieve offers associated with the user input control. In an embodiment, a user input control selectable to retrieve an offer may be a button labeled with a brand name such as the button for a store labeled “kmart” 2318 described in conjunction with FIG. 23. Those skilled in the art will appreciate that various user input elements provided in a graphical user interface of an offer application may be selectable to retrieve an offer. At step 2404, an indication may be received that the user input control was selected to retrieve the offers associated with the user input control.

At step 2406, the offers associated with the user input control may be requested. In an embodiment, an offer application 206 may send a request to a consumer offer application 244 executing on an offer server 242 to send offers associated with the user input control. At step 2408, the offers associated with the user input element may be received, including offers extracted from a marketing communications inbox. For instance, the offers extracted in an embodiment may be retrieved from persistent storage such as offer 284 in server storage 278 described in conjunction with FIG. 2. In an embodiment, a user identifier and a restriction flag may be associated with an offer extracted from a marketing message in a user's marketing email inbox that is stored in persistent storage with an offer 284 in server storage 278 of FIG. 2. In this embodiment, the restriction flag may indicate that the offer extracted from a marketing message in a user's marketing email inbox may be retrieved for display to the user whose marketing email inbox received the marketing message and that the offer extracted from the marketing message in a user's marketing email inbox may not be retrieved for display to other users. In other embodiments, an offer extracted from a marketing message in a user's marketing email inbox may be retrieved for display to other users. And at step 2410, the offers, including offers extracted from a marketing communications inbox, may be displayed. Those skilled in the art will appreciate that the marketing message from the marketing communications inbox that includes the offer may be retrieved and displayed in an embodiment, or an offer generated from the message may instead be retrieved and display in various other embodiments.

Importantly, the offers extracted and loaded into persistent storage may be served to users of an online offer service through a variety of user interfaces where the relevance of the extracted offers may be specified by a user's interests. Thus the system and method allow a consumer to easily discover relevant offers online even if such offer were sent to their email inbox. Moreover, notification settings may be flexibly configured by a user for offers extracted from new marketing messages received. A user may specify the frequency of notification as well as notification channels such as an instant message or alert sent to a computing device such as a mobile phone or a computer for display by a variety of applications.

As can be seen from the foregoing detailed description, the present invention provides a system and method for generating offers from marketing communications. More particularly, the present invention may receive marketing communications, including marketing emails, and store them in a centralized storage such as a marketing communication inbox. Promotional offers may then be generated from marketing communications and stored for serving to users of an online offer service. Conveniently, the present invention may easily organize incoming messages to help users distinguish between deal-related commercial correspondence and other kinds of email messages. Furthermore, the invention may flexibly allow an online consumer to easily discover relevant offers in their email inbox for products they want and brands they like. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system with a graphical user interface for providing information about offers, comprising:
an offer application user interface that displays information about a promotional offer extracted from a message for a recognized brand received in an email inbox of a user; and
an offer application operably coupled to the offer application user interface that receives the information about the promotional offer extracted from the message for the recognized brand received in the email inbox of the user.

2. The system of claim 1 further comprising a consumer offer application executing on a server operably coupled to the offer application that sends the information about the promotional offer extracted from the message for the recognized brand received in the email inbox of the user.

3. The system of claim 2 further comprising a consumer application programming interface operably coupled to the consumer offer application that is invoked to retrieve the information about the promotional offer extracted from the message for the recognized brand received in the email inbox of the user.

4. A method for providing information about offers in a graphical user interface of a computing device, comprising:
displaying a user interface input element selectable to retrieve information of a promotional offer extracted from a message for a recognized brand received in an email inbox of a user;
receiving an indication that the user interface input element was selected to retrieve the information of the promotional offer extracted from the message for the recognized brand received in the email inbox of the user; and
displaying the information of the promotional offer extracted from the message for the recognized brand received in the email inbox of the user offer.

5. The method of claim 4 further comprising:
sending a request to retrieve the information of the promotional offer extracted from the message for the recognized brand received in the email inbox of the user; and
in response to sending the request, receiving the information of the promotional offer extracted from the message for the recognized brand received in the email inbox of the user.

6. The method of claim 4 further comprising:
receiving information to notify the user about a plurality of messages received in the email inbox of the user for at least one of a plurality of recognized brands; and
displaying the information to notify the user about the plurality of messages received in the email inbox of the user for the at least one of the plurality of recognized brand.

7. The method of claim 4 further comprising:
receiving information to notify the user about a plurality of messages received in the email inbox of the user for at least one of a plurality of recognized brands selected by the user; and
displaying the information to notify the user about the plurality of messages received in the email inbox of the user for the at least one of the plurality of recognized brand selected by the user.

8. The method of claim 4 further comprising:
receiving information to notify the user about a plurality of messages received in the email inbox of the user for at least one of a plurality of recognized brands not selected by the user; and
displaying the information to notify the user about the plurality of messages received in the email inbox of the user for the at least one of the plurality of recognized brand not selected by the user.

9. The method of claim 4 wherein displaying the information of the promotional offer extracted from the message for the recognized brand received in the email inbox of the user comprises displaying an offer generated from the information of the promotional offer extracted from the message for the recognized brand received in the email inbox of the user.

10. The method of claim 4 wherein displaying the information of the promotional offer extracted from the message for the recognized brand received in the email inbox of the user comprises displaying the message for the recognized brand received in the email inbox of the user.

11. A method for providing information about offers in a graphical user interface of a computing device, comprising:
displaying a user interface input element selectable to retrieve a plurality of promotional offers associated with the user input element;
receiving an indication that the user interface input element was selected to retrieve the plurality of promotional offers associated with the user input element; and
displaying the plurality of promotional offers associated with the user input element with at least one promotional offer of the plurality of promotional offers extracted from a message for a recognized brand received in an email inbox of a user.

12. The method of claim 11 further comprising:
sending a request to retrieve the plurality of promotional offers associated with the user input element; and
in response to sending the request, receiving the plurality of promotional offers associated with the user input element with the at least one promotional offer of the plurality of promotional offers extracted from the message for the recognized brand received in the email inbox of the user.

13. The method of claim 11 wherein displaying the user interface input element selectable to retrieve the plurality of promotional offers associated with the user input element comprises displaying the user interface input element selectable to retrieve the plurality of promotional offers associated with a brand.

14. The method of claim 11 wherein displaying the user interface input element selectable to retrieve the plurality of promotional offers associated with the user input element comprises displaying the user interface input element selectable to retrieve the plurality of promotional offers associated with a product category.

15. The method of claim 11 wherein displaying the user interface input element selectable to retrieve the plurality of promotional offers associated with the user input element comprises displaying a text input box for entering a search string to retrieve the plurality of promotional offers as search results for the search string.

16. The method of claim 11 wherein displaying the user interface input element selectable to retrieve the plurality of promotional offers associated with the user input element comprises displaying the user interface input element selectable to retrieve the plurality of promotional offers associated with a place.

17. A computer-readable storage medium having computer-executable instructions for performing the method comprising:
displaying a user interface input element selectable to retrieve information of a promotional offer extracted from a message for a recognized brand received in an email inbox of a user;
receiving an indication that the user interface input element was selected to retrieve the information of the promotional offer extracted from the message for the recognized brand received in the email inbox of the user; and
displaying the information of the promotional offer extracted from the message for the recognized brand received in the email inbox of the user offer.

18. The computer-readable storage medium having computer-executable instructions for performing the method of claim 11 further comprising:
sending a request to retrieve the information of the promotional offer extracted from the message for the recognized brand received in the email inbox of the user; and
in response to sending the request, receiving the information of the promotional offer extracted from the message for the recognized brand received in the email inbox of the user.

19. A computer system for providing offers, comprising:
means for displaying a user interface input element selectable to retrieve a plurality of promotional offers associated with the user input element;
means for receiving an indication that the user interface input element was selected to retrieve the plurality of promotional offers associated with the user input element; and
means for displaying the plurality of promotional offers associated with the user input element with at least one promotional offer of the plurality of promotional offers extracted from a message for a recognized brand received in an email inbox of a user.

20. The computer system of claim 19 further comprising:
means for sending a request to retrieve the plurality of promotional offers associated with the user input element; and
means for receiving the plurality of promotional offers associated with the user input element with the at least one promotional offer of the plurality of promotional offers extracted from the message for the recognized brand received in the email inbox of the user.
